(19) United States
(12) Patent Application Publication
(10) Pub. No.: US 2007/0297641 A1
(43) Pub. Date: Dec. 27, 2007

(54) CONTROLLING CONTENT SUITABILITY BY SELECTIVELY OBSCURING

(75) Inventors: Linda Criddle, Kirkland, WA (US); David Milstein, Redmond, WA (US)

Correspondence Address: VIERRA MAGEN/MICROSOFT CORPORATION, 575 MARKET STREET, SUITE 2500, SAN FRANCISCO, CA, 94105, US

(73) Assignee: MICROSOFT CORPORATION, Redmond, WA (US)

(21) Appl. No.: 11/426,912

(22) Filed: Jun. 27, 2006

(51) Int. Cl. G06K 9/00; G06K 9/40

(52) U.S. Cl. 382/100; 382/264

(57) ABSTRACT

Content (e.g., still image, video, animation or other content) received via a network (or other source) may or may not be suitable for a particular user. Thus, prior to displaying, the content is automatically screened by a screening application and assigned a suitability value. If the suitability value is within a specific range of values, the content is altered to obscure (e.g., blur) the content so that the content will be difficult to view. The obscured content is displayed. A user can request that the content be restored to its original form, thereby, removing the alteration that obscured the content.

### BACKGROUND

As the Internet has become more popular, additional content has become available and more people are accessing that content. Because there is little restriction on what can be made available on the Internet, there is opportunity for content to be made available that is inappropriate for certain persons. For example, images that depict violent or sexual content may be inappropriate for children, as well as some adults.

To prevent inappropriate images from being provided, various services have screened images prior to presentation. In some instances, images are manually screened. However, manual screening may not always be practical. Therefore, some organizations will use software to automatically screen images. One software system looks for certain shapes or images associated with violence or sexual content. Another software system looks for a predefined amount of pixels in an image that have the same color as human skin. Because these applications are not accurate enough, images that are identified by these automated software programs as being potentially inappropriate are then manually reviewed. Those images that are identified as being inappropriate after the manual review are then blocked from being displayed on the Internet.

One problem with the above-described systems for controlling content is that for organizations that deal with large volumes of images, manually reviewing the image's that are identified as potentially inappropriate by the software systems can be expensive and prone to error.

Another problem with the above-described systems for controlling content is that different users of the Internet have different thresholds for what is appropriate. Additionally, a particular user's threshold for what is appropriate may change based on the environment or conditions that the user is currently experiencing. For example, a user that is alone in a room may be willing to see a different set of images than a user with children in the room.

### SUMMARY

Technology is provided that allows users to customize what they will and will not view in a manner that allows for updating of what the user will view in real time.

In one embodiment, content (e.g., still image, video, animation or other content) delivered via a network (or other source) is automatically screened by a screening application and assigned a suitability value. If the suitability value is within a specific range of values, the content is altered to obscure the content so that the content will be difficult to view. The obscured content is displayed. A user can request that the content be restored to its original form, thereby, removing the alteration that obscured the content. In one implementation, the altering of the content and display of the altered content is automatically performed by the user's computing device.

In one example, a user attempts to download an image with or without other content. If the suitability value assigned to the image is within a range designated by the user, then the image is blurred and the blurred image is then displayed to the user with a slider. The user can move the slider, which causes the blurring to be removed.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram of one embodiment of a system for controlling content.

FIG. 2 is a block diagram of one embodiment of a system for controlling content.

FIG. 3 is a block diagram of one embodiment of a system for controlling content.

FIG. 4 is a block diagram of one embodiment of a system for controlling content.

FIG. 5 is a block diagram of one embodiment of a system for controlling content.

FIG. 6 is a block diagram of one embodiment of a system for controlling content.

FIG. 7 is a block diagram of one embodiment of a system for controlling content.

FIG. 8 is a flow chart describing one embodiment of a process for establishing user preferences for controlling content.

FIG. 9 is a flow chart describing one embodiment of a process for analyzing images.

FIG. 10 is a flow chart describing one embodiment of a process for controlling content.

FIGS. 11 and 12 depict content displayed in a user interface.

FIG. 13 is a flow chart describing one embodiment of a process for controlling content.

FIG. 14 is a flow chart describing one embodiment of a process for controlling content.

FIG. 15 is a flow chart describing one embodiment of a process for controlling content.

FIGS. 16A and 16B are flow charts describing one embodiment of a process for controlling content.

FIG. 17 is a flow chart describing one embodiment of a process for controlling content.

FIG. 18 is a block diagram depicting one example of a computing environment suitable for implementing the technology described herein.

### DETAILED DESCRIPTION

In one embodiment, content is automatically screened by a screening application and assigned a suitability value. User will have previously set up preferences that identify a range of suitability values for content that should be blocked, a range of suitability values for content that should be allowed, and a range of suitability values for content that should be obscured. If the suitability value for content is within the range to be blocked for a particular user, then when that user attempts to download or otherwise access the content, the content will be blocked. If the suitability value for content is within the range to be allowed for a particular user, then when that user attempts to download or otherwise access the content, the content will be provided as requested. If the suitability value for content is within the range to be obscured for a particular user, then when that user attempts to download or otherwise access the content, the content will be altered to obscure (e.g., blur) the content so that the content gives a general sense of the image but details will be difficult to view. The obscured content is displayed. A user can choose for themself if they want the content to be visible and can select to have the content restored to its original form, thereby, removing the alteration that obscured the content. In one embodiment, the obscuring and displaying of the obscured content is performed automatically, without human intervention.

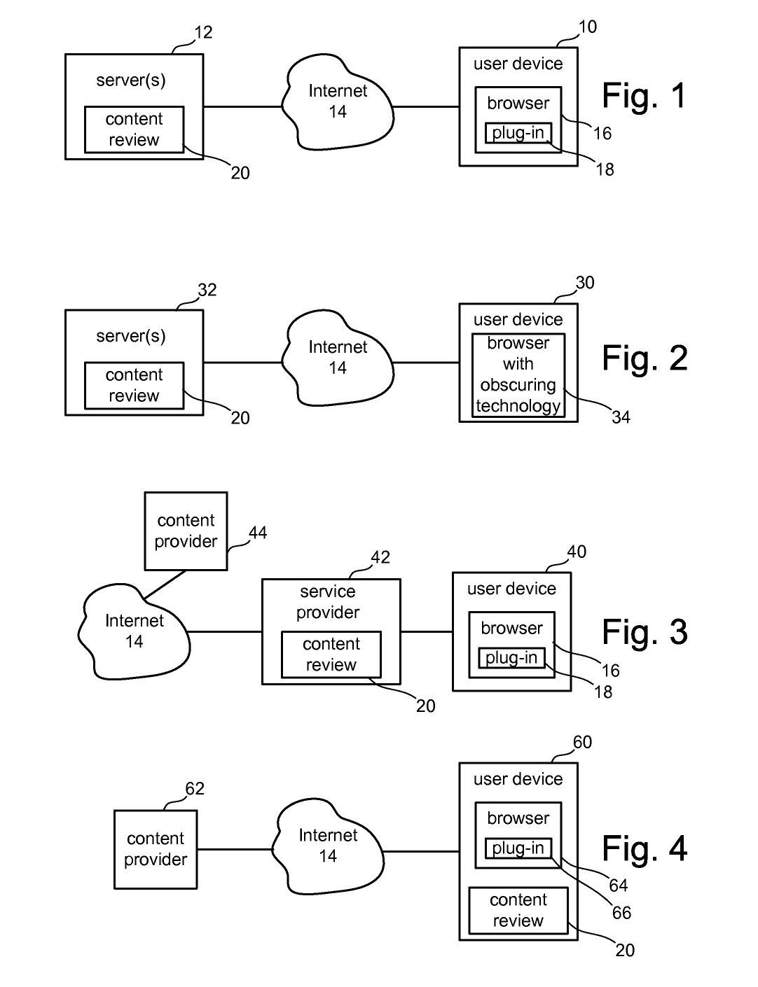

FIG. 1 depicts one embodiment of a system for controlling content as described herein. The embodiment of FIG. 1 pertains to a system that analyzes content and determines the suitability value on a central server, with the obscuring of the content being performed by a plug-in to a browser on the client device. FIG. 1 shows client computing device 10 in communication with one or more servers 12 via Internet 14. In some embodiments, a network other than the Internet can be used in addition to or instead of Internet 14. For example, other types of wired networks and wireless networks can be used. Client computing device 10 can be any type of computing device that can perform the method described herein, such as a desktop computer, laptop computer, handheld computing device, telephone, organizer, etc. Client computing device 10 includes a browser 16, which can be any suitable browser (e.g., Internet Explorer from Microsoft Corporation), and a plug-in 18 to browser 16. Plug-in 18, as described below, is used to cause the obscuring of the content downloaded from servers 12.

Servers 12 include one or more servers that are used to implement a web site and/or web service. For example, servers 12 can be used to provide a web portal, a news service, content storage service, communication service, or other type of service. The technology described here in is not limited to any type of service. Servers 12 include content review application 20. Content review application 20 analyzes content and assigns a suitability value to the content. The suitability value is an indicator of how offensive the content is. For example, the suitability value may be a number between 1 and 100, with 100 indicating the content is suitable for all audiences and 1 indicating that the content is offensive to all audiences. Suitability values between 1 and 100 indicate a range of confidence that the image is or is not offensive. For example, a suitability value of 60 indicates that there is a 60% chance that a person would find the content suitable. Other scales (e.g., other than 1-100 can also be used). In some embodiments, there can be multiple suitability values so that there is one suitability value for sexual content, one suitability value for violent content, and so on. In one embodiment, content review application 20 is one of the many software applications known in the art that automatically analyze an image for sexual or violent content. Some software applications looks for certain shapes or images associated with violence or sexual content. Other applications look for a predefined amount of pixels in an image that have the same color as human skin.

In one embodiment, servers 12 store the user preferences that identify a range of suitability values for content that should be blocked, a range of suitability values for content that should be allowed, and a range of suitability values for content that should be obscured. When a user requests content, servers 12 will block the content if the suitability value for the content is in the range of suitability values for content that should be blocked. Otherwise, servers 12 will provide the content, the suitability value, and a command indicating whether to obscure or allow the content to user device 10. If the command indicates that the content should be obscured, then plug-in 18 will obscure the content prior to being displayed in browser 16.

In some embodiments, plug-in 18 will either obscure or not obscure the content. In other embodiments, plug-in 18 can obscure the content to different degrees based on the suitability value. For example, a low suitability value will result in a very blurry image while a higher suitability value will result in a less blurry image.

In some embodiments, the user preferences can be stored on client device 10, in which servers 12 will transmit the content with the suitability value, and plug-in 18 will decide whether to obscure the content. The user preferences can also be stored at other locations.

FIG. 2 depicts another embodiment of a system for controlling content as described herein. The embodiment of FIG. 2 pertains to a system that analyzes content and determines the suitability value on a central server, with the obscuring of the content being performed by a browser on the client device. FIG. 2 shows a client computing device 30 in communication with one or more servers 32 via Internet 14. Client computing device 30 includes a browser 34 that includes the technology for obscuring an image and restoring the image, as described herein. Servers 32, which include content review application 20, comprise one or more servers that are used to implement a web site and/or web service.

FIG. 3 depicts another embodiment for controlling content as described herein. The embodiment of FIG. 3 pertains to an environment where a service provider other than the content provider, for example an Internet Service Provider, analyzes content being transmitted to customers of the service providers. The service provider will determine the suitability value and the obscuring of the content will be performed by a browser on the user device based on the suitability value. FIG. 3 shows a user computing device 40 accessing Internet 14 via service provider system 42. User computing device 40 includes a browser 16 and plug-in 18. Service provider system 42 includes content review application 20.

FIG. 4 depicts another embodiment of a system for controlling content as described herein. The embodiment of FIG. 4 includes a user device that analyzes the content it receives, determines the corresponding suitability value, and obscures the content based on the determined suitability value. FIG. 4 shows a user computing device 50 in communication receiving content from a content provider 62 via Internet 14. User computing device 60 includes a browser 64 and browser plug-in 66. Browser plug-in 66 performs the obscuring of the content. User computing device 60 also includes content review application 20. Thus, technology described herein for controlling the content is performed on the user device. In one embodiment, content provider 62 can be a server, a device in a peer-to-peer situation, a wireless device, etc.

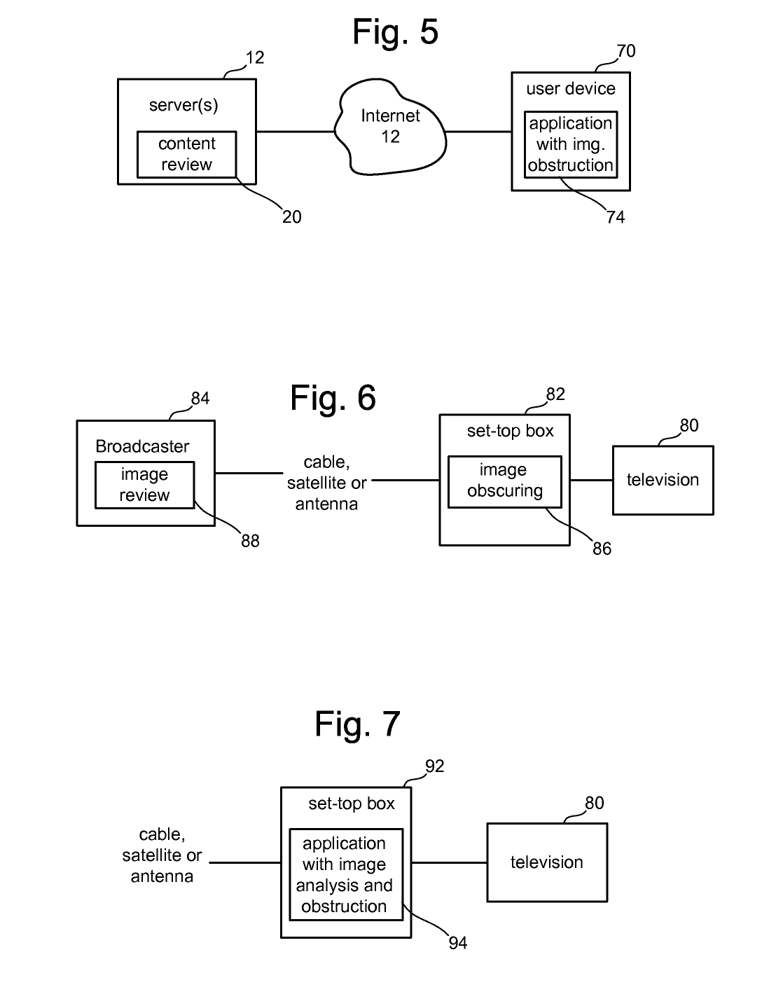

FIG. 5 depicts another embodiment of a system for controlling content as described herein. The embodiment of FIG. 5 pertains to a system that analyzes content and determines the suitability value on a central server, with the obscuring of the content being performed by one or more applications on the user device 70. FIG. 5 shows a user computing device 70 in communication with one or more servers 12 via Internet 14. Application 74 is installed on user computing device 70. Application 74 includes the technology for obscuring an image and restoring the image, as described herein.

In addition to controlling the suitability of content transmitted over a network, the technology described herein can be used to control content transmitted via other means. One example includes controlling content provided to a television or other video monitor via traditional airwaves, cable television distribution, satellite television distribution, or other means. FIG. 6 describes one such embodiment where the content review is performed at the Broadcaster and the obscuring is performed at a set-top box or other client side device. FIG. 6 shows television 80 receiving video from set-top box or other client side device 82. Many different types of set-top boxes or other client side device can be used. Set-top box or other client side device 82 receives video or other content from broadcaster system 84 via traditional airwaves, cable television distribution, satellite television distribution or other means. Set-top box or other client side device 82 includes image obscuring application 86. In some embodiments, the technology for implementing set-top box or other client side device 82 can be built into television 80. Broadcaster system 84 includes image review application 88, which analyzes content (e.g., video) and assigns a suitability value to the content.

FIG. 7 is another embodiment pertaining to a system for controlling content provided to a television or other video monitor. FIG. 7 shows television 80 receiving video from set-top box or other client side device 92, which receives content via traditional airwaves, cable television distribution, satellite television distribution or other means. Set-top box or other client side device 92 includes an application 94 that analyzes video images to assign a suitability value to the video images and then obscures the video images based on the suitability value.

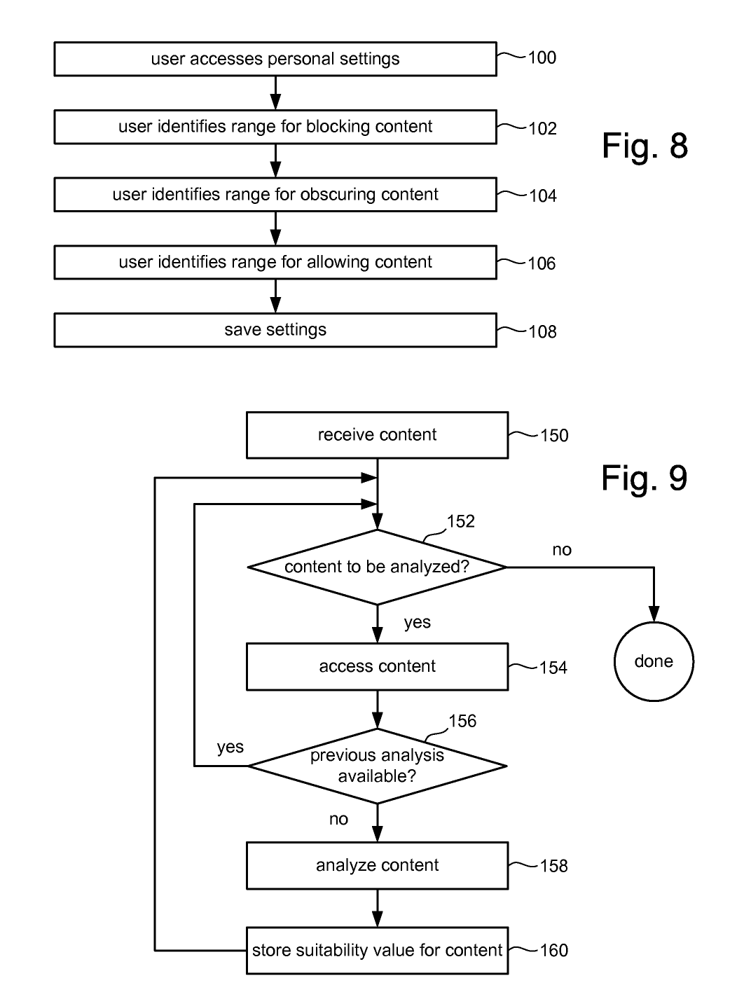

As described above, once content has been analyzed and assigned a suitability value, a decision is made as to whether to block, allow or obscure the content based on the user's personal settings. FIG. 8 is a flow chart describing one embodiment of a process for establishing the user's personal settings.

In step 100 of FIG. 8, a user will access the user's personal settings. These personal settings can be stored on the user device, the central servers (e.g., servers 12) or a different device. In step 102, the user will identify a range of suitability values corresponding to content that the user (or the user's guardian) wants blocked. For example, if suitability values can be between 1 and 100, the user may indicate that content that receives a suitability value of 50 or less is to be blocked. In step 104, the user will identify a range of suitability values corresponding to content that should be obscured. For example, if suitability values can be between 1 and 100, the user may indicate that content that receives a suitability value greater than 50 and less 75 should be obscured. In step 106, the user will identify a range of suitability values corresponding to content that should be allowed to be displayed as is. For example, if suitability values can be between 1 and 100, the user may indicate that content that receives a suitability value greater than or equal to 75 should be allowed. Steps 102-106 can be performed using a graphical user interface on an application or within a browser. In step 108, the personal settings from steps 102-106 are saved. In one embodiment, there may also be a personal setting that when set prevents the user from removing the obscuring of the content (e.g., prevents step 218, below, from being performed). In some embodiments, a default set of personal settings may be used until a user (or guardian) creates new personal settings. In one embodiment, parents/guardians, as a part of establishing parental controls (family safety settings) for their children have set the image filtering standards and that these automatically apply to the child when the child signs into any service.

FIG. 9 is a flow chart describing one embodiment of a process for reviewing content. In one embodiment, the method of FIG. 9 is performed on servers 12 or 32. In step 150, servers 12 or 32 receive new content, become aware of new content, or otherwise act on content. In step 152, it is determined whether there is any content to be analyzed. For example, if the system is set up to analyze images, then step 153 includes determining whether there are any images to review. If not, the process of FIG. 9 is completed. If there is content to review, then the content is accessed in step 154. In step 156, it is determined whether the accessed content had been reviewed before. For example, if the content is an image then step 156 includes determining whether the image has already been analyzed and received a suitability value from a trusted source. In one embodiment, when an image (or other content) is analyzed, the suitability value is stored in a persistent data store along with a hash of the image. If that image were to show up again, its hash would match the stored hash and the system knows that the image has already been analyzed and what the prior suitability value was. If, in step 156, it is determined that the content has analyzed before and the suitability value is available, then the previously determined suitability value is used and the process loops back to step 152 to see if there is additional content to be analyzed. If, in step 156, it is determined that the content has not been analyzed before, then the content is analyzed in step 158 and a suitability value is determined in step 158. Note that step 158 is performed by content review application 20. In step 160, the suitability value is stored and the process loops back to step 152 to see if there is additional content to be analyzed. The process of FIG. 9 can be performed when new content is made available at the servers, when a user requests content, or at another suitable time.

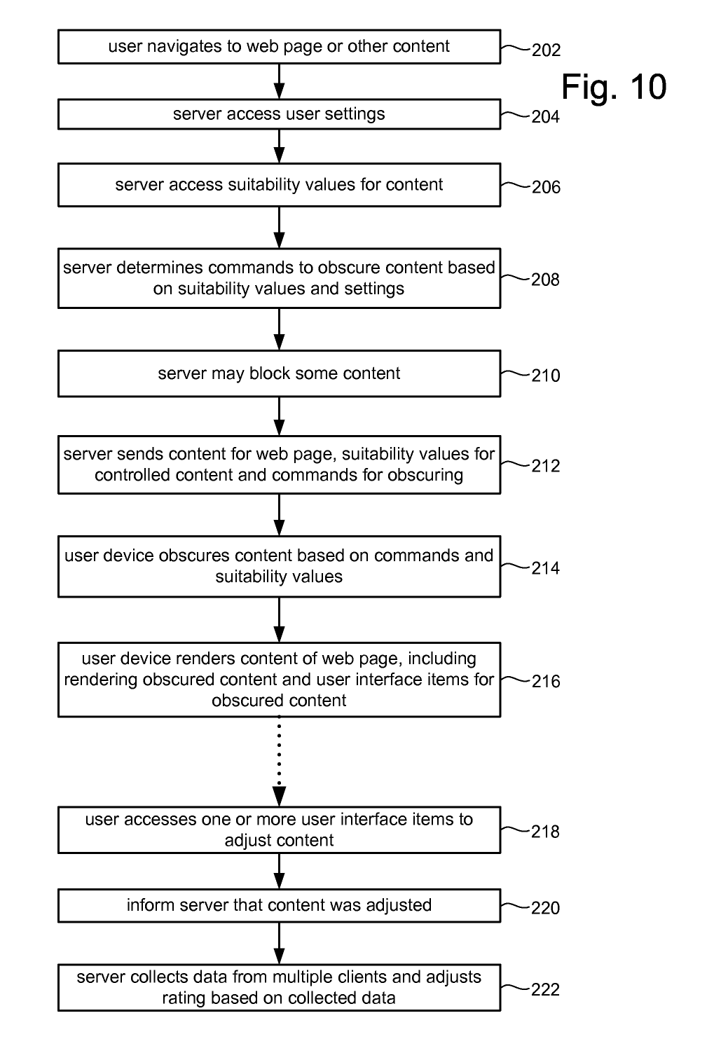

FIG. 10 is a flow chart describing one embodiment of a process for controlling content when a user attempts to access the content. For example, the process of FIG. 10 may be performed when a user accesses a web page in the embodiments of FIGS. 1, 2 and 5. The process of FIG. 10 applies to the systems that store the personal settings on the server or at a location accessible to the server. In step 202, the user navigates to and attempts to access a portion of a web page (or other content). The server (e.g. servers 12 or 32), will access the content/data for the web page (or other content). Prior to providing the web page to the user in response to the request from the user, the server will access the personal settings (see FIG. 8) that are stored on the server in step 204. In step 206, the server will access the suitability values for any content that is being controlled. For example, the server will access any suitability values for any images to be displayed in the web page. In step 208, the server will determine a command for each item of content being controlled. For example, if an image has a suitability value in the range for obscuring content (e.g., >50 and <75), then the server will determine that the proper command for that image is the command to obscure the image. If an image has a suitability value in the range for allowing content (e.g., >75), then the server will determine that the proper command for that image is the command to allow the image. Other commands can also be used. In one embodiment, content with a suitability value in the range for blocking content (e.g., <50) will be blocked from the user in step 210. In other embodiments, the server may instead issue a command for the user device to block the content.

In step 212, the server sends to the user device the information for the web page, including the content to be controlled, the suitability values and the commands. In step 214, the user device obscures the content based on the suitability values and/or the commands. For example, if an image is associated with a command to allow the image, then the image will not be obscured. However, if the image is associated with a command to obscure the image, then the image will be obscured. One example of obscuring is to blur the image. In one embodiment, the amount of blurring is based on the suitability value. In another embodiment, there will be only one amount of blurring used. Other types of obscuring can also be used, such as distorting the image or other effects. In step 216, the web page, including any obscured content, is rendered in the browser. For each content that is obscured, an interface item (e.g., slider, knob, button, check box, etc.) is rendered that can be used by the user to reduce or remove the obscuring.

In step 218, the user accesses one or more of the interface items for the obscured content to indicate that the content should not be obscured anymore and should be restored to its original state. For example, the user may slide the slider, turn the knob, push the button, check the box, etc. Another option allows the user to right-click using a mouse and select a menu item to remove the obscuring. If the interface item has a variable setting, then the amount of obscuring can be variable. For example, the more the slider is moved, the less blurry the image becomes.

In one embodiment of step 218, the user will be prompted to enter a password and that password will be verified. The system will only remove the obscuring in response to verifying the password. Using a password may be a means to prevent children from accessing inappropriate content. The personal settings may include the ability to set up the password. Note that there is a dashed line between steps 216 and 218 because in some cases a user may not wish to remove the obscuring of the content.

If the user removed the obscuring of the content, the user device may inform the server that the obscuring was removed in step 220. The server will collect such data from multiple user devices in step 222. If enough user devices removed the obscuring, then the suitability value may be adjusted based on the received data to indicate a value indicating higher suitability. Note that steps 220 and 222 are optional and may not be implemented in systems where users are concerned about privacy.

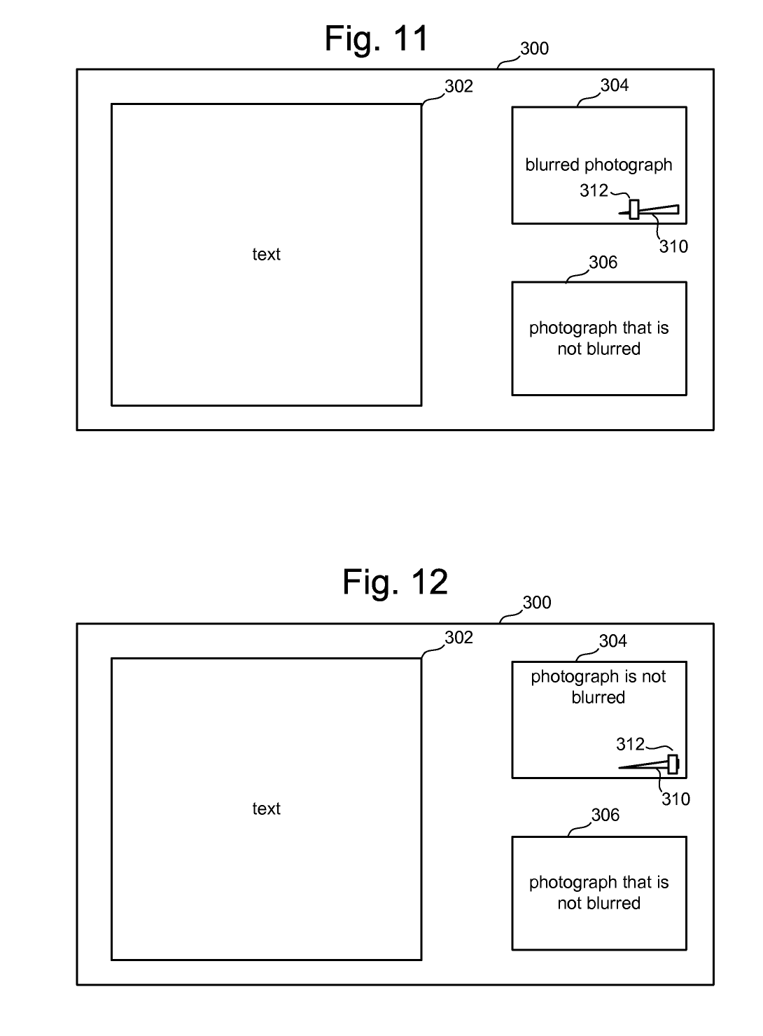

FIG. 11 depicts a web page 300 being displayed, such as a news articles with text 302, a first photograph 304 and a second photograph 306. First photograph 304 has a suitability value that is in the range for obscuring, so it is blurred and rendered with a slider 310. Note that bar 312 of slider 310 is in the far left position indicating the maximum blurring. Second photograph 306 has a suitability value in the range for allowing content, so it has been allowed and rendered with no blurring.

Because photograph 304 is blurry, it is difficult to see the details of the photograph but a general sense of the content is retained allowing the user to decide for themselves if they want to bring the image into better focus. If the user wants to see photograph 304, the user will move bar 312 of slider 310 toward the right side of slider 310. FIG. 12 shows the same web page after the user moved bar 312 to the far right side of slider 310. As a result, FIG. 12 shows photograph 302 as not being blurry.

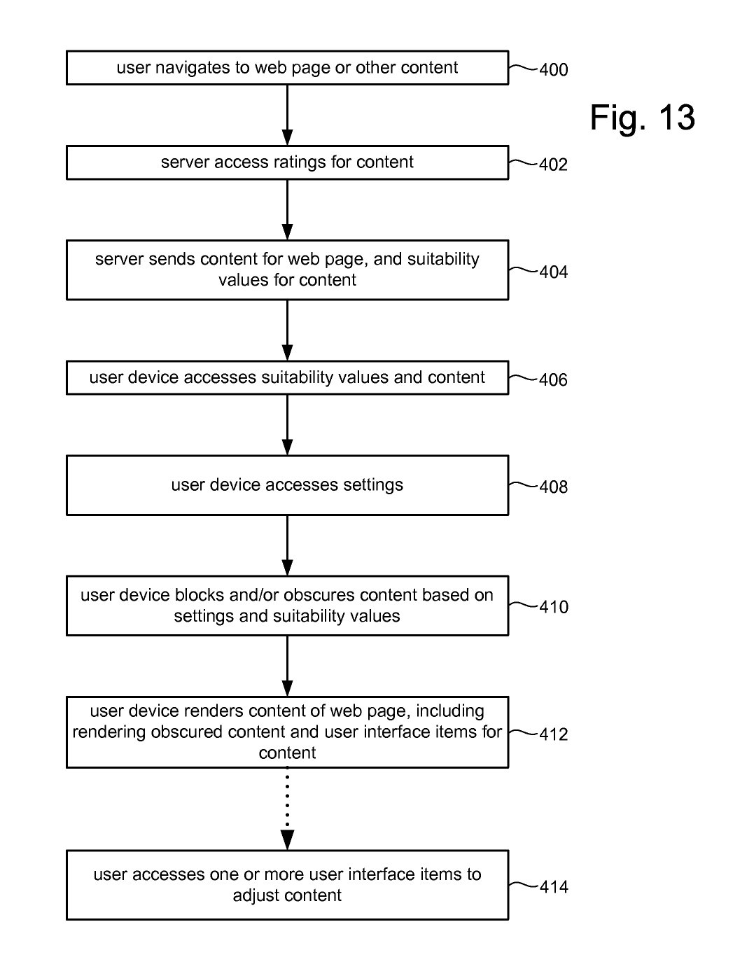

FIG. 13 is a flow chart describing another embodiment of a process for controlling content when a user attempts to access the content. For example, the process of FIG. 13 may be performed when a user accesses a web page in the embodiments of FIGS. 1, 2 and 5. The process of FIG. 13 applies to the systems that store the personal settings on the user device or at a location accessible to the user device. In step 400, the user navigates to and attempts to access a portion of a web page using the user device. The server (e.g. servers 12 or 32), will access the content for the web page. The server will access the suitability values for any content to be controlled. For example, the server may access suitability values for all images on a web page. In step 404, the server sends the web page, including the content and the suitability values, to the user device. In step 406, the user device accesses the received web page, including the content and corresponding suitability values. In step 408, the user device accesses the personal settings. In step 408, the user device applies the personal settings to the suitability values. Content with a suitability value in the range to block will be blocked. Content with a suitability value in the range to obscure will be obscured. Content with a suitability value in the range to allow will be allowed. In step 412, the user device will render the web page, including rendering the allowed content and the obscured content (with the interface item to be used to remove the obscuring). In step 414, the user accesses one or more of the interface items for the obscured content to indicate that the content should not be obscured anymore and should be restored to its original state. There is a dashed line between steps 412 and 414 because in some cases a user may not wish to remove the obscuring of the content. In some embodiments, the process of FIG. 13 can include steps 220 and 22 of FIG. 10.

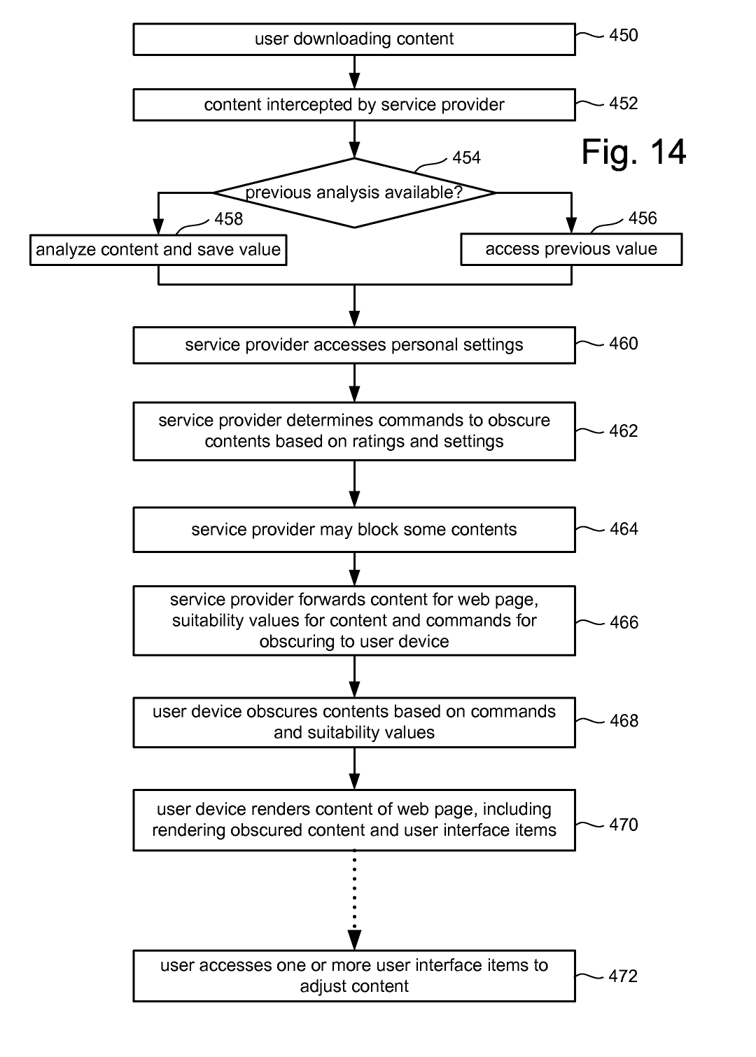

FIG. 14 is a flow chart is describing another embodiment of a process for controlling content when a user attempts to access the content. The process of FIG. 14 may be performed when a user accesses a web page and the content is controlled by a service provider, for example, as depicted in the embodiment of FIG. 3. In step 450, the user starts downloading content, which may be a web page or other content. In step 452, the content is intercepted by service provider 42 (see FIG. 3), and content that should be controlled is identified. In step 454, it is determined whether the content that should be controlled has been previously analyzed (e.g., by the server or another trusted source) and, if so, whether the suitability value is available. If the content was previously analyzed, the previous suitability value is accessed in step 456. If not, content review application 20 on service provider system 42 is used to analyze the content, determine a suitability value, and save that determined suitability value. In step 460, service provider system 42 accesses the personal settings. In step 462, service provider 42 determines whether the content should be blocked, allowed or obscured, and issues the appropriate command based on the suitability value and the personal settings. In step 464, service provider system 42 may block the content that was determined to have a suitability value in the range for blocked content. In step 466, service provider 42 forwards the content, suitability values, and commands (see step 462) to the user device.

In step 468, the user device obscures the content based on the suitability values and/or the commands. For example, if an image is associated with a command to allow the image, then the image will not be obscured. However, if the image is associated with a command to obscure the image, then the image will be obscured. In step 470, the web page or other content, including any obscured content, is rendered in the browser or other application. For content that is obscured, an interface item (e.g., slider, knob, button, check box, etc.) is rendered that can be used by the user to remove the obscuring. In step 472, the user accesses one or more of the interface items for the obscured content to indicate that the content should not be obscured anymore and should be restored to its original state. There is a dashed line between steps 470 and 472 because in some cases a user may not wish to remove the obscuring of the content. Alternatively, a parent may be needed to remove the obscuring.

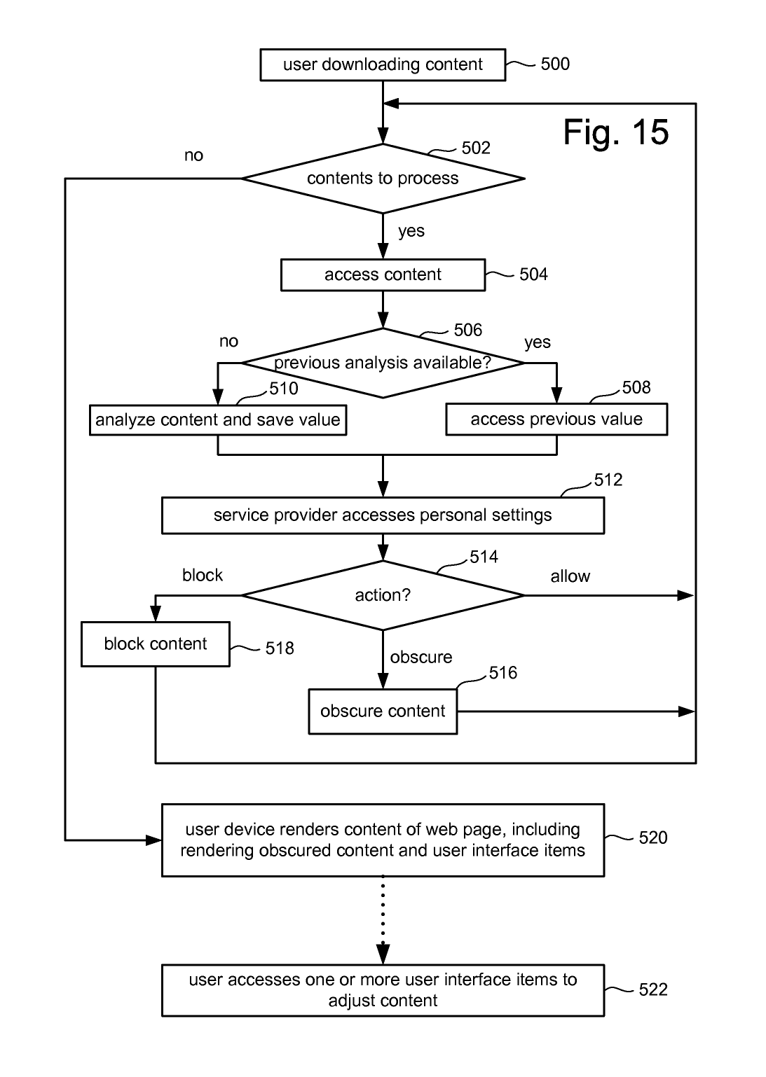

FIG. 15 is a flow chart describing another embodiment of a process for controlling content when a user attempts to access the content. The process of FIG. 15 may be performed when all (or most) of the technology for controlling content is located on the user device. One example of such an embodiment is depicted in FIG. 4. In step 500, the user downloads content to user device 60, which may be a web page or other content. In step 502, user device 60 determines whether there is any content that needs to be processed (e.g., whether there are any images to process). If so, one element of the content (e.g., one image) is accessed in step 504 and it is determined in step 506 whether a suitability value has already been determined for that content. If the content was previously analyzed, the previous suitability value is accessed in step 508. If not, content review application 20 on user device 60 is used to analyze the content, determine a suitability value, and save that determined suitability value. In step 512, user device 60 accesses the personal settings.

Based on the personal settings and the suitability value, an action is determined in step 514. If the content has a suitability value in the range for allowing content, then the process will loop back to step 502 to process additional content, if any. If the content has a suitability value in the range for obscuring, then plug-in 66 of user device 60 will obscure the content in step 516. If the content has a suitability value in the range for blocking, then plug-in 66 of user device 60 will block the content from being displayed in step 518. After steps 516 and 518, the process will loop back to step 502 to process additional content, if any.

When there is no more content to process (see step 502), user device 60 renders the web page or other content, including any obscured content, within browser 64 in step 520. For each content that is obscured, an interface item (e.g., slider, knob, button, check box, etc.) is rendered that can be used by the user to remove the obscuring. In step 522, the user accesses one or more of the interface items for the obscured content to indicate that the content should not be obscured anymore and should be restored to its original state. There is a dashed line between steps 520 and 522 because in some cases a user may not wish to remove the obscuring of the content.

In a simple deployment (light on the client side), if there is no value established for an incoming image then the device will block the image and require that the image be sent via the server for rating. This might be the best solution in the peer-to-peer scenarios where a heavier client is perhaps more difficult to get in.

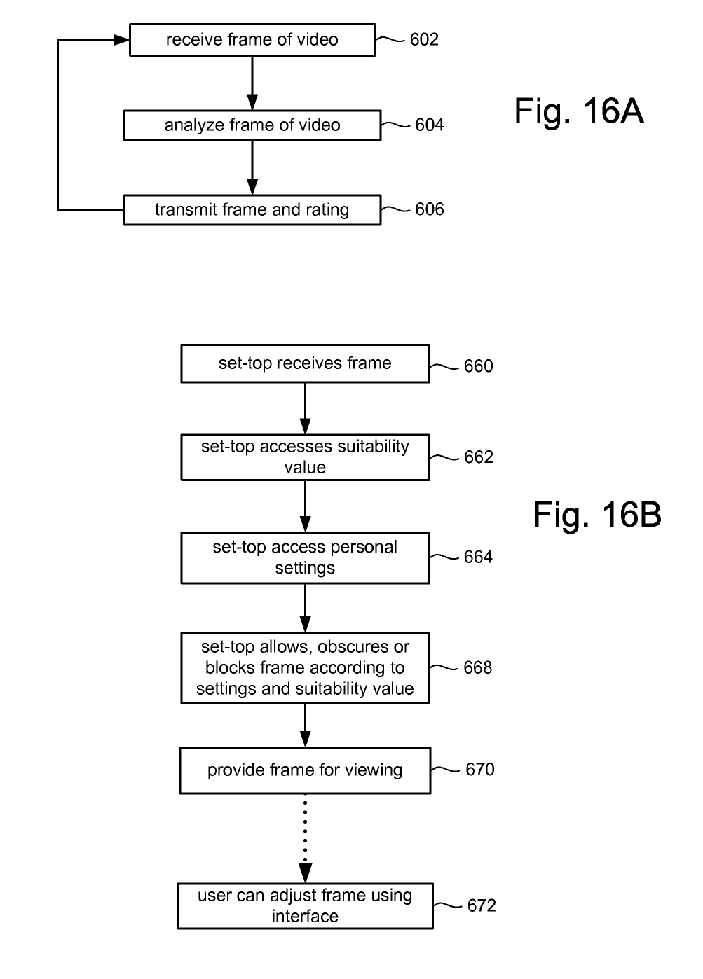

FIGS. 16A and 16B are flow charts describing an embodiment of a process for controlling content when a user attempts to access the content using a television or other video monitor. One example of such an embodiment is depicted in FIG. 6. The process of FIG. 16A is performed on broadcaster system 84. In step 602, a frame (or other unit) of video is received, created or otherwise detected. In step 604, the frame of video is analyzed by content review application 88 to determine whether the frame of video has objectionable content. A suitability value is determined and stored. In step 606, the frame of video is transmitted using various means (e.g., airwaves, cable, satellite, or other) known in the art. When the frame of video is transmitted, the determined suitability value is also transmitted. In one embodiment, the data for the video is digital data and the suitability value is included with the digital data. In another embodiment, the suitability value can be transmitted in the vertical blanking interval or otherwise encoded in the video signal. After (or concurrently with) transmitting the frame of video, the process loops back to step 602 and the next frame of video is processed.

FIG. 16B is performed on set-top box or other client side device 82. In step 660, set-top box or other client side device 82 receives a frame of video from broadcaster system 84. In step 662, set-top box or other client side device 82 accesses the suitability value provided by broadcaster system 84 for the frame of video. In step 664, set-top box or other client side device 82 accesses the personal settings. In step 668, image obscuring application 86 of set-top box or other client side device 82 allows, obscures or blocks the frame (or portion of the frame) based on the suitability value and the personal settings. In step 670, set-top box or other client side device transmits the frame to the television for viewing with the frame blocked (e.g., black frame, blank frame, or other blocking mechanism) or obscured, as determined in step 668. In step 672, the user accesses one or more of the interface items (e.g., button or dial on the remote control) for the set-top box or other client side device to indicate that the content should not be obscured anymore and should be restored to its original state. There is a dashed line between steps 670 and 672 because in some cases a user may not wish to remove the obscuring of the content.

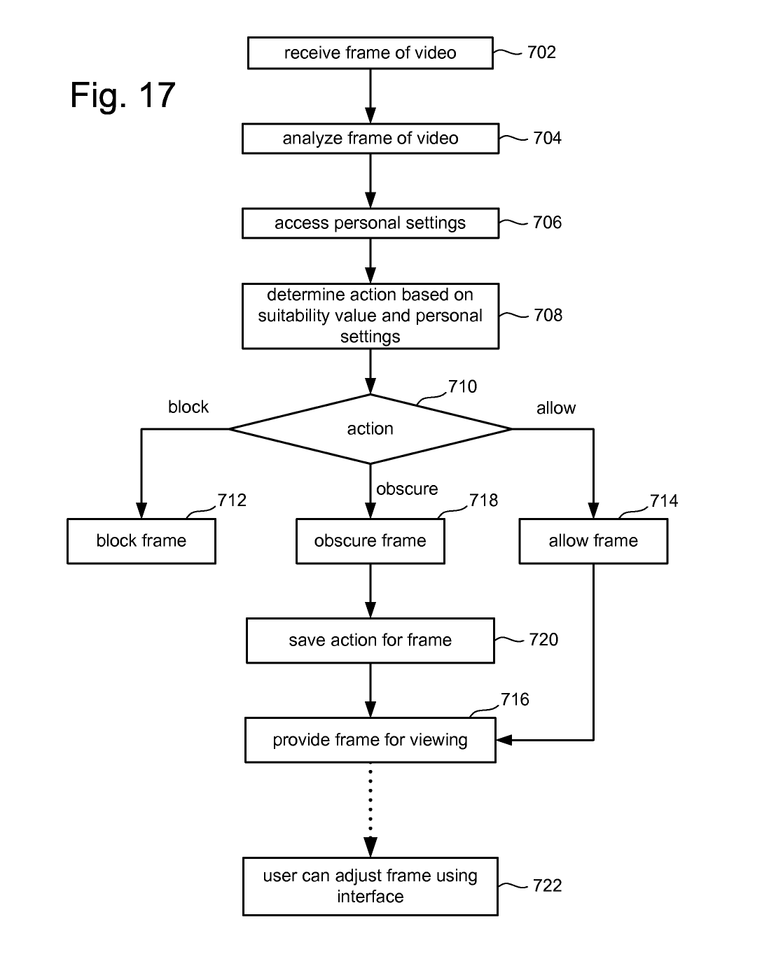

FIG. 17 is a flow chart describing another embodiment of a process for controlling content when a user attempts to access the content using a television or other video monitor. One example of such an embodiment is depicted in FIG. 7. In step 702, set-top box or other client side device 92 receives a frame (or other unit) of video. In step 704, application 94 analyzes the frame of video and determines a suitability value. In step 706, application 94 accesses the personal settings. In step 708, application 94 determines an action based on the personal settings and the suitability value. If the frame has a suitability value in the range for blocking content, then application 94 will block the viewing of the frame in step 712. If the frame has a suitability value in the range for allowing content, then application 94 will allow the frame in step 714 and provide that frame for viewing to television 80 in step 716. If the content has a suitability value in the range for obscuring, then application 94 will obscure the frame in step 718 and provide that obscured frame for viewing to television 80 in step 716. In step 722, the user accesses one or more of the interface items (e.g., button or dial on the remote control) for the set-top box or other client side device to indicate that the content should not be obscured anymore and should be restored to its original state. There is a dashed line between steps 716 and 722 because in some cases a user may not wish or need to remove the obscuring of the content.

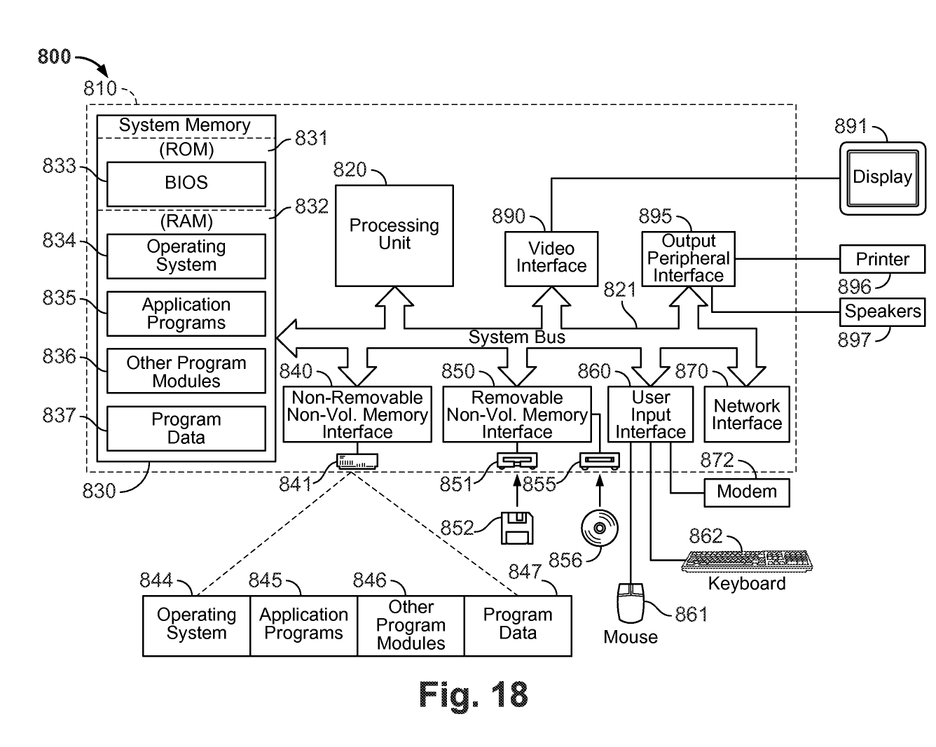

FIGS. 1-7 depicts users devices, servers, set-top boxes or other client side devices. These computing devices can be implemented by various different computing environments. FIG. 18 illustrates one example of a suitable general computing environment 800 that may be used to implement the various components illustrated in FIGS. 1-7. For example, computing system 800 can be used to implement user client computing devices 10, 30, 40, 60 and 70; servers 12 and 32; service provider system 42; set-top box or other client side devices 82 and 92; and broadcaster system 84. Computing system 800 is only one example of a suitable computing environment and is not intended to suggest any limitation as to the scope of use or functionality of the technology described herein. Neither should computing system 800 be interpreted as having any dependency or requirement relating to any one or combination of components illustrated in the exemplary operating environment 800.

The technologies described herein are operational with numerous general purpose or special purpose computing system environments or configurations. Examples of well known computing systems, environments, and/or configurations that may be suitable for use include, but are not limited to, personal computers, server computers, hand-held or laptop devices, personal digital assistants, telephones (wired, wireless, or cellular), multiprocessor systems, microprocessor-based systems, set top boxes, programmable consumer electronics, network PCs, minicomputers, mainframe computers, distributed computing environments that include any of the above systems or devices, and the like.

The system may be described in the general context of computer-executable instructions, such as program modules, being executed by one or more computers/processors. Generally, program modules include routines, programs, objects, components, data structures, etc., that perform particular tasks or implement particular abstract data types. The system may also be implemented in distributed computing environments where tasks are performed by remote processing devices that are linked through a communications network. In a distributed computing environment, program modules may be located in both local and remote computer storage media including memory storage devices.

With reference to FIG. 18, an exemplary system includes a general purpose computing device in the form of computer 810. Components of computer 810 may include, but are not limited to, a processing unit 820 (which can include multiple processors), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 810.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 18 illustrates operating system 834, application programs 835, other program modules 836, and program data 837. In one example, application programs 835 may include the content review applications and browser plug-ins and program data 837 may include the suitability values and personal settings.

The computer 110 may also include other removable/non-removable, volatile/nonvolatile computer storage media. By way of example only, FIG. 18 illustrates a hard disk drive 841 that reads from or writes to non-removable, nonvolatile magnetic media, a magnetic disk drive 851 that reads from or writes to a removable, nonvolatile magnetic disk 852, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and magnetic disk drive 851 and optical disk drive 855 are typically connected to the system bus 821 by a removable memory interface, such as interface 850.

The drives and their associated computer storage media discussed above and illustrated in FIG. 18, provide storage of computer readable instructions, data structures, program modules and other data to program the processor(s) to perform the methods described herein. In FIG. 18, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies. In one example, application programs 845 may include the content review applications and browser plug-ins and program data 847 may include the suitability values and personal settings.

A user may enter commands and information into the computer 20 through input devices such as a keyboard 862 and pointing device 861, commonly referred to as a mouse, trackball or touch pad. Other input devices (not shown) may include a microphone, joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A monitor 891 or other type of display device is also connected to the system bus 821 via an interface, such as a video interface 890. In addition to the monitor, computers may also include other peripheral output devices such as speakers 897 and printer 896, which may be connected through a output peripheral interface 890.

When used in a LAN networking environment, computer 810 is connected to a LAN through a network interface or adapter 870. When used in a WAN networking environment, computer 810 typically includes a modem 872, network interface or other means for establishing communications over the WAN, such as the Internet. The modem 872, which may be internal or external, may be connected to the system bus 821 via the user input interface 860, or other appropriate mechanism. Although an example computing environment is depicted with respect to FIG. 18, other computing systems can also be used.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. It is intended that the scope of the invention be defined by the claims appended hereto.

We claim:

1. A method for controlling visual content, comprising:
receiving visual content;
obscuring said visual content based on a suitability indicator; and
causing said obscured visual content to be displayed.

2. A method according to claim 1, further comprising:
receiving an indication from a user to correct said visual content; and
correcting said visual content so that said visual content is not obscured in response to receiving said indication.

3. A method according to claim 2, wherein:
said visual content includes an image;
said obscuring said visual content includes blurring said image;
said correcting said visual content includes displaying said image without blurring; and
said obscuring and said causing are performed automatically.

4. A method according to claim 1, further comprising:
receiving user authentication; and
correcting said visual content so that said visual content is not obscured at least partially in response to verifying said receiving said user authentication.

5. A method according to claim 1, wherein:
said obscuring includes providing a degree of obscuring based on said suitability indicator.

6. A method according to claim 1, further comprising:
receiving said suitability indicator from a server via a network, said visual content is received at a computing device from said server via said network, said obscuring is performed at said computing device.

7. A method according to claim 1, further comprising:
receiving a variable indication from a user; and
removing said blurring in response to and in proportion to said variable indication.

8. A method according to claim 7, wherein:
said method further comprises receiving user preference information;
said obscuring is based on said user preference information,
said visual content includes an image;
said user preference information indicates a first range for blocking images, a second range for blurring images and a third range for allowing images;
said obscuring said visual content includes blurring said image if said suitability indicator is in said second range; and
said correcting said visual content includes displaying said image without blurring.

9. A method according to claim 1, further comprising:
analyzing said visual content to determine said suitability indicator.

10. A method according to claim 9, wherein:
said visual content is received at a computing device from a server via said network;
said obscuring is performed at said computing device;
said analyzing is performed by said server; and
said method further includes transmitting said suitability indicator to said computing device.

11. A method according to claim 9, wherein:
said visual content is received at a computing device from a server via said network;
said obscuring is performed at said computing device;
said analyzing is performed by a service provider in communication with said server and said computing device; and
said method further includes transmitting said suitability indicator to said computing device from said service provider.

12. A method according to claim 1, wherein:
said visual content includes any one of a still image, animation and a video.

13. A method according to claim 1, wherein:
said visual content is received at a set-top device;
said set-top device is in communication with a video monitor; and
said obscuring is performed at said set-top device.

14. One or more processor readable storage devices storing processor readable code for programming one or more processors to perform a method comprising:
receiving an image at a computing device, said image is received from a network;
blurring said image based on a suitability indicator associated with said image, said blurring is performed by said computing device; and
causing said blurred image to be displayed at said computing device.

15. One or more processor readable storage devices according to claim 14, wherein:
said blurring includes providing a degree of blurring based on said suitability indicator.

16. One or more processor readable storage devices according to claim 14, wherein said method further includes:
receiving an indication from a user; and
removing said blurring in response to said indication.

17. One or more processor readable storage devices according to claim 14, wherein said method further includes:
accessing user preference information; said user preference information indicates a first range for blocking images, a second range for blurring images and a third range for allowing images; and
determining that said suitability indicator is associated with said second range, said blurring is performed in response to said determining that said suitability indicator is associated with said second range.

18. A computing device, comprising:
an input/output interface;
a storage device; and
a processor in communication with said storage device and said input/output device; said processor accesses an image, said processor accesses a suitability indicator and user preference information, said processor alters said image to make said image difficult to view clearly based on said suitability indicator and said user preference information, said processor causes said altered image to be displayed.

19. A computing device according to claim 18, wherein:
said processor causes said image to be displayed clearly in response to an input from a user.

20. A computing device according to claim 18, wherein:
said image can be a frame of video or a still image; and
said user preference information provides at least a first range for said suitability indicator and a second range for said suitability indicator;
said suitability indicator is a number; and
said process alters said image by blurring said image after determining that said suitability indicator is within said first range.
